(19) United States
(12) Patent Application Publication
(10) Pub. No.: US 2009/0268321 A1
(43) Pub. Date: Oct. 29, 2009

(54) SIDE MIRROR ASSEMBLY FOR A MOTOR VEHICLE

(75) Inventor: Douglas J. Wilson, Ft. Gratiot, MI (US)

Correspondence Address: REISING ETHINGTON P.C., P O BOX 4390, TROY, MI, 48099-4390, US

(73) Assignee: Visiocorp Patents S.a.r.l., Luxembourg (LU)

(21) Appl. No.: 12/107,936

(22) Filed: Apr. 23, 2008

(51) Int. Cl. G02B 5/10

(52) U.S. Cl. 359/868; 359/838; 359/850

(57) ABSTRACT

A mirror includes a substrate of transparent material defining a first side and a second side. The second side includes a primary mirror surface defining a first focal axis and a secondary mirror surface defining a second focal axis. The second focal axis is directed in a direction different than the first focal axis.

### BACKGROUND ART

1. Field of the Invention

The invention relates to vehicular side mirrors. More particularly, the invention relates to vehicular side mirrors having spot mirrors having an orientation such that the field of view of the spot mirror greatly reduces the blind spot for a driver of the motor vehicle.

2. Description of the Related Art

Multiple mirrors in a rear view mirror assembly are common. The multiple mirrors include a primary mirror and what is typically referred to as a secondary or spot mirror. This secondary mirror is located somewhere adjacent the primary reflective surface and is used to aid the user of the motor vehicle to increase his field of view around the motor vehicle.

The spot mirror is typically spherical in shape because that is the most widely known method for grinding glass. This results in a spot mirror that has a circular periphery. One such disclosure is found in U.S. Pat. No. 6,199,993. Control of the round, semi-spherical spot mirrors limits the ability of the mirror design to more fully provide as much as a field of view as possible to the driver. In addition, positioning of the auxiliary mirror with regard to the primary mirror is difficult and requires precision to ensure that the field of view of each of the mirrors or reflective surfaces are aligned properly to maximize the ability of the user to increase the field of view rearward of the motor vehicle.

### SUMMARY OF THE INVENTION

A mirror includes a substrate of transparent material defining a first side and a second side. The second side includes a primary mirror surface defining a first focal axis and a secondary mirror surface defining a second focal axis. The second focal axis is directed in a direction different than the first focal axis.

### BRIEF DESCRIPTION OF THE DRAWINGS

Advantages of the invention will be readily appreciated as the same becomes better understood by reference to the following detailed description when considered in connection with the accompanying drawings, wherein:

FIG. 1 is a side view of a mirror assembly having mirror glass incorporating one embodiment of the invention;

FIG. 2 is a cross-sectional side view, partially cut away, taken along lines 2-2 of FIG. 1; and

FIG. 3 is a top view of a motor vehicle, partially cut away, with the invention secured thereto and schematically identifying focal axis created by the mirror.

### DETAILED DESCRIPTION OF THE PREFERRED EMBODIMENT

Referring to the Figures, an exterior rearview mirror assembly is generally indicated at 10. The exterior rear view mirror assembly 10 is fixedly secured to a motor vehicle 12 on a side 14 thereof. While only one exterior rearview mirror assembly 10 is shown, it should be appreciated by those skilled in the art that a second exterior rearview mirror assembly 10 may be fixedly secured to a side opposite the side 14 of the motor vehicle 12.

The exterior rearview mirror assembly 10 includes a bracket, graphically represented by a bracket cover 16. The bracket 16 is mounted to the side 14 of the motor vehicle 12. The mounting thereof is covered by a sail 18, which is an aesthetic piece that is also able to improve the aerodynamics of the exterior rearview mirror assembly 10.

The exterior rearview mirror assembly 10 also includes a mirror casing 20. The mirror casing is secured to the bracket 16. The mirror casing 20 defines a primary opening 22. The primary opening 22 faces rearward of the motor vehicle 12. For purposes of this disclosure, the direction rearward is the direction opposite the direction in which the motor vehicle 12 is going when it is driving in a forward direction. Therefore, the mirror casing 20 includes a forward surface 24 which extends forward of the exterior rearview mirror assembly 10. The mirror casing 20 is generally closed but for a primary opening 22. In many embodiments, the mirror casing 20 includes exterior lighting units for illuminating the mirror casing 20, a portion thereof, or the ground below, depending on the particular situation. Examples of lighting units include turn signals and ground illumination lighting units. Such units may be incorporated into the mirror casing 20 without deviating from the invention.

The mirror casing 20 also includes a neck 26 which extends out from the mirror casing 20 and is received by the bracket 16. It should be appreciated by those skilled in the art that the function of the neck 26 may be assumed by the bracket 16 resulting in a mirror casing 20 without a neck 26.

The exterior rearview mirror assembly 10 includes a mirror, generally shown at 28. The mirror 28 includes a substrate of transparent material 30. In the embodiment shown, the substrate of transparent material is glass. It should be appreciated by those skilled in the art that the substrate of transparent material 30 may be some other material other than glass that is hard, transparent and can hold its shape in the varying and sometimes hostile environment in which the motor vehicle 12 operates.

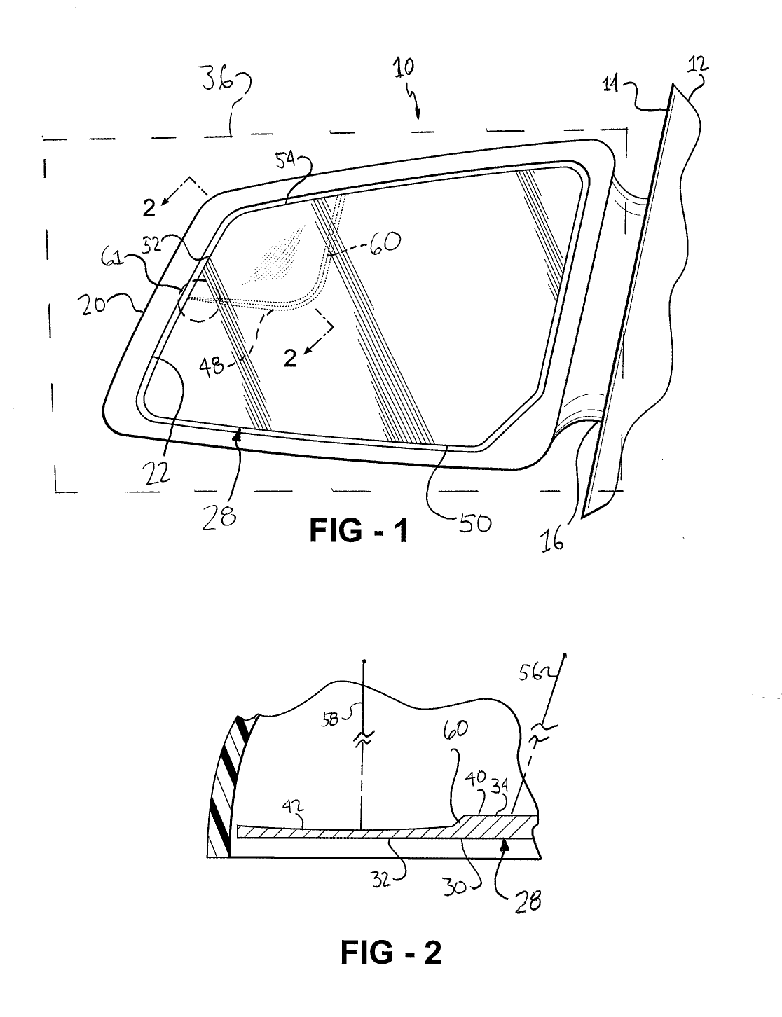

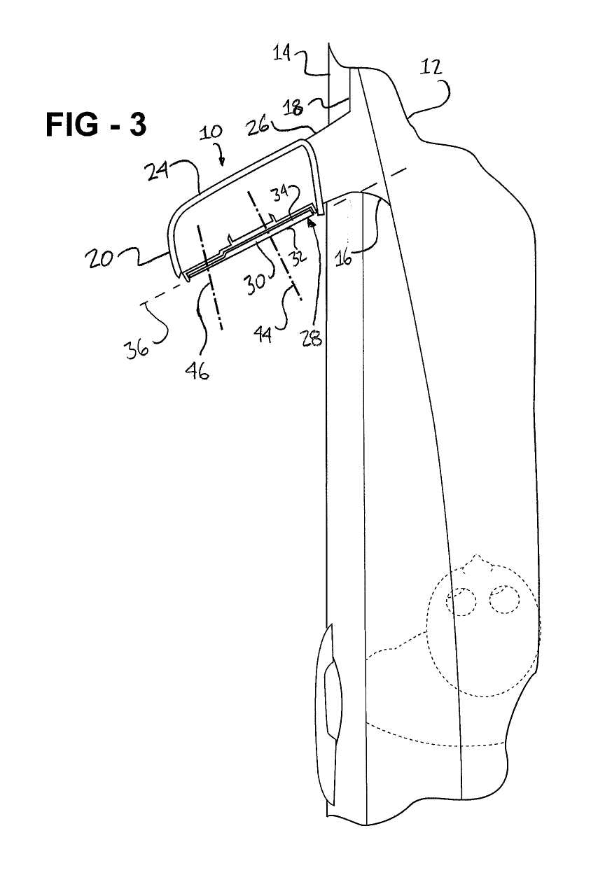

Referring to FIG. 2, the substrate of transparent material 30 defines a first side 32 and a second side 34. The first side 32 of the substrate of transparent material 30 defines a flat plane 36 (shown in FIGS. 1 and 3). The second side 34 includes a reflective coating (not shown) that is applied to the second side 34 of the substrate of transparent material 30. The reflective coating 38 may be a chrome-based application or any other application that would provide a maximum amount of uniform reflection of visible light that passes through the substrate of transparent material 30.

The second side 34 of the substrate of transparent material 30 includes a primary mirror surface 40 and a secondary mirror surface 42. The primary mirror surface 40 defines a first focal axis 44 and the second mirror surface 42 defines a second focal axis 46. The second focal axis 46 defines a direction that is different than a direction defined by the first focal axis 44. More specifically, the first focal axis 44 is not the same focal axis as the second focal axis 46. As is shown in FIG. 1, from a top view it appears that the first focal axis 44 and the second focal axis 46 intersect. When the mirror 28 is in the configuration as that shown, the first 44 and second 46 focal axes actually do not intersect because they are offset spatially in the vertical direction due to the secondary mirror surface 42 being formed in the upper left hand corner of the mirror 28. It should be appreciated by those skilled in the art that the secondary mirror surface 42 may be positioned so that the first 44 and second 46 focal axes do intersect. Regardless of whether they intersect, the first 44 and second 46 focal axes are not parallel to each other.

The secondary mirror surface 42 defines a periphery 48 that is not regular. More specifically, the periphery 48 of the secondary mirror surface 42 is irregular. The periphery 48 does not define a circle. While not necessarily the case, the periphery 48 of the secondary mirror surface includes a portion of a periphery 50 of the primary mirror surface 40. In the embodiment shown in FIG. 2, the periphery of the secondary surface 42 includes four sides, of which two sides 52, 54 are also included in the periphery 50 of the primary mirror surface 40.

In addition, the primary mirror surface 40 defines a primary radius of curvature 56. The secondary mirror surface 42 defines a secondary radius of curvature 58. The secondary radius of curvature 58 is less than the primary radius of curvature 56. By having the secondary radius of curvature 58 smaller than the primary radius of curvature 56, the secondary mirror surface 42 acts as a spot mirror having a greater field of view and more distortion than that of the primary radius of curvature 56 which is substantially flat. As is well known in the art, the driver side mirror includes a primary mirror surface 40 that defines a primary radius of curvature 56 that is infinitely long resulting in a flat mirror surface, whereas the passenger side mirror includes a primary mirror surface 40 that defines a radius of curvature that is less than infinite.

A relief 60 is a surface that extends between the primary mirror surface 40 and the secondary mirror surface 42. The relief 60 allows the primary mirror surface 40 to have a first thickness that is greater than a second thickness of the substrate of transparent material 30, which is associated with the secondary mirror surface 42. As can be seen in circle 61 of FIG. 1, the relief 60 is not uniform in depth. The relief 60 varies in depth based on the asymmetric design of the secondary mirror surface 42, as well as its orientation with respect to the primary mirror surface 40, the relationship of which is graphically represented by first and second focal axes 44, 46. There is no need for a demarcation line to extend between the primary 40 and secondary 42 mirror surfaces unless it is desired for aesthetic purposes.

The secondary mirror surface 42 is formed in the primary mirror surface 40 by grinding that portion of the primary mirror portion 42 to create the secondary mirror surface 42. The grinding to create the secondary mirror surface 42 is a processing step further or in addition to the process that is used to create the primary mirror surface 40. The grinding is controlled by a CNC machine or the like to ensure the non-circular periphery 48 of the secondary mirror surface 42 includes a secondary mirror surface 42 that will reflect light in the manner visible by the operator 62 of the motor vehicle 12 allowing the operator 62 to be able to use the information in that light to determine whether an object is in the field of view of the secondary mirror surface 42.

Alternatively, the secondary mirror surface 42 may be formed through a molding process. In this instance the entire substrate of transparent material 30 would be formed via a molding process. Using this “mold-in” method, the substrate of transparent material 30 would be something other than glass.

The invention has been described in an illustrative manner. It is to be understood that the terminology, which has been used, is intended to be in the nature of words of description rather than of limitation.

Many modifications and variations of the invention are possible in light of the above teachings. Therefore, within the scope of the appended claims, the invention may be practiced other than as specifically described.

1. A mirror comprising:
a substrate of transparent material defining first and second sides;
said second side including a primary mirror surface defining a first thickness and a first focal axis defining a first line, said primary mirror surface defining a primary radius of curvature; and
said second side including a secondary mirror surface having a second thickness less than said first thickness, and a second focal axis defining a second line wherein said second focal axis is directed in a direction different than said first focal axis, said secondary mirror surface defining a second radius of curvature less than said primary radius of curvature.

2. (canceled)

3. A mirror as set forth in claim 10 wherein said secondary mirror surface defines an irregular periphery.

4. A mirror as set forth in claim 3 wherein said primary mirror surface defines a non-circular periphery.

5. (canceled)

6. (canceled)

7. (canceled)

8. A mirror as set forth in claim 4 wherein said first side defines a plane.

9. A mirror as set forth in claim 8 including a reflective coating applied to said second side.

10. A mirror as set forth in claim 2 including a relief extending between said primary and secondary mirror surfaces.

11. (canceled)

12. (canceled)

13. A mirror as set forth in claim 9 wherein said secondary mirror surface defines a second periphery.

14. A mirror as set forth in claim 13 wherein said primary mirror surface defines a first periphery different from said second periphery.
